(19) United States
(12) Patent Application Publication
(10) Pub. No.: US 2012/0037466 A1
(43) Pub. Date: Feb. 16, 2012

(54) BRAKE DRUM AND METHOD FOR MANUFACTURING THE SAME

(75) Inventors: Jae Young Lee, Yongin (KR); Seong Jin Kim, Yongin (KR); Jai Min Han, Ansan (KR); Yoon Cheol Kim, Seoul (KR); Shin Gyu Kim, Incheon (KR)

(73) Assignee: HYUNDAI MOTOR COMPANY, Seoul (KR)

(21) Appl. No.: 12/947,286

(22) Filed: Nov. 16, 2010

(30) Foreign Application Priority Data
Aug. 10, 2010 (KR) 10-2010-0076857

(51) Int. Cl. F16D 65/10; B23K 31/02; C22F 1/00

(52) U.S. Cl. 188/218 R; 148/531

(57) ABSTRACT

A method of manufacturing a brake drum for a vehicle is provided, which comprises: bonding at a temperature of 500° C. or higher a braking surface of a brake drum which is made of a gray cast iron material with a housing which is to accommodate the braking surface and is made of an aluminum alloy material; and removing residual stress that remains in the gray cast iron material by heating the braking surface at a temperature of about 600° C. The brake drum can improve fuel efficiency of a vehicle and drive comfort while having excellent braking performances.

### CROSS-REFERENCE TO RELATED APPLICATION

This application is based on and claims priority from Korean Patent Application No. 10-2010-0076857, filed on Aug. 10, 2010, the disclosure of which is incorporated herein in its entirety by reference.

### BACKGROUND OF THE INVENTION

1. Field of the Invention

The present invention relates to a brake drum for a vehicle and a method for manufacturing the same, which can improve fuel efficiency and drive comfort of the vehicle and/or improve braking performances.

2. Description of the Related Art

In general, a brake drum is a kind of brake which generates braking force even if a drum that is rotated together with a wheel is rotated in any direction, i.e., in the forward or backward direction, and has a function of automatically controlling the brake lining wear.

On the other hand, in order to prevent the corrosion of the brake drum, a brake disc or the brake drum is coated, and in this case, the braking surface area is coated using a coating agent that can be removed by a grinding operation of the brake linings.

However, the braking surface of the brake drum in the related art has the drawback in that its strength security is lowered to deteriorate the safety, and also has the problem that if a component is added to reinforce the strength, the weight of a vehicle is increased to deteriorate the fuel economy.

The above information disclosed in this Background section is only for enhancement of understanding of the background of the invention and therefore it may contain information that does not form the prior art that is already known in this country to a person of ordinary skill in the art.

### SUMMARY OF THE INVENTION

In one aspect of the present invention, there is provided a method of manufacturing a brake drum for a vehicle, which comprises: bonding at a temperature of 500° C. or higher a braking surface which is made of a gray cast iron material with a housing which is made of an aluminum alloy material and is to accommodate the braking surface; and removing residual stress that remains in the gray cast iron material by heating the braking surface at a temperature of about 600° C.

In another aspect, there is provided a brake drum for a vehicle, which comprises: a braking surface made of a gray cast iron material; and a housing made of an aluminum alloy material, wherein the braking surface and the housing are bonded and the bonding portion of the braking surface is formed in a wave shape.

In still another aspect, there is provided a brake drum for a vehicle, which comprises: a braking surface made of a gray cast iron material; and a housing made of an aluminum alloy material, wherein the gray cast iron material comprises iron (Fe) as a principal component, 3.0 to 3.8 w % of carbon (C), 1.0 to 2.8 w % of silicon (Si), 1.0 or less w % of manganese (Mn), 0.2 or less w % of phosphorus (P), and 0.15 or less w % of sulfurs and the aluminum alloy material comprises aluminum (Al) as a principal component, 0.1 or less w % of copper (Cu), 5.5 to 8.5 w % of silicon (Si), 0.15 to 0.5 w % of magnesium (Mg), 0.1 or less w % of zinc (Zn), 0.3 or less w % of iron (Fe), 0.1 or less w % of manganese (Mn), 0.2 or less w % of titanium (Ti), and 0.15 or less w % of antimony (Sb).

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other aspects will be described in detail below.

### BRIEF DESCRIPTION OF THE DRAWINGS

The above and other features and advantages of the present invention will be more apparent from the following detailed description taken in conjunction with the accompanying drawings, in which:

FIG. 1 is a view illustrating a brake drum according to an embodiment of the present invention;

FIG. 2 is a view illustrating a braking surface and a housing of a brake drum according to an embodiment of the present invention;

FIG. 3 is a view illustrating a braking surface of a braking drum according to an embodiment of the present invention;

FIG. 4 is a view illustrating a gravity casting process that can be used in a method of manufacturing a brake drum according to an embodiment of the present invention; and

FIG. 5 is a diagram illustrating a thermal treatment that can be used in a method of manufacturing a brake drum according to an embodiment of the present invention.

### DETAILED DESCRIPTION OF THE EMBODIMENTS

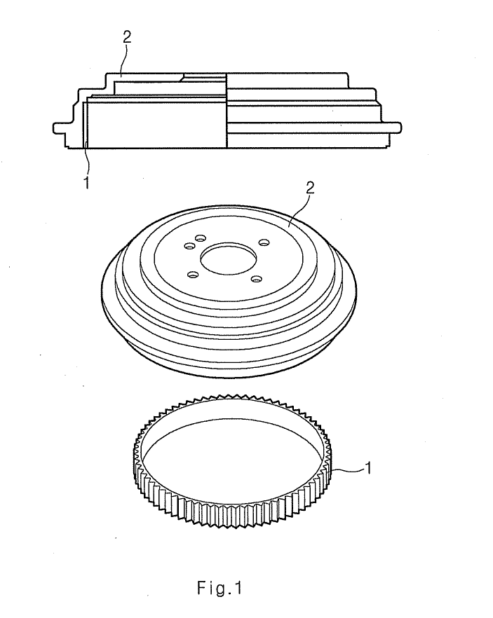

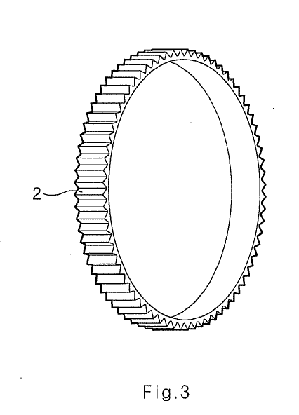

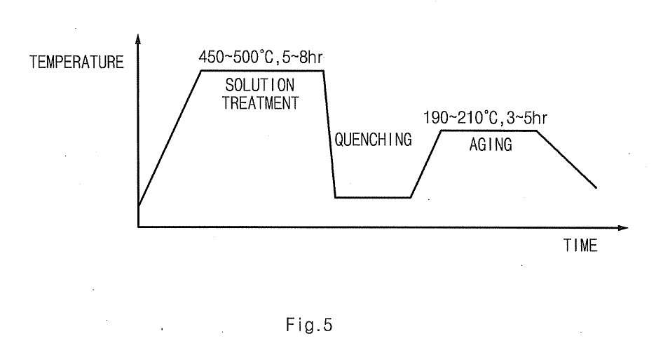

Hereinafter, a brake drum for a vehicle and a method for manufacturing the same according to embodiments of the present invention will be described with reference to FIGS. 1 to 5.

According to at least one of the embodiments, residual stress that remains in a gray cast iron material is removed by adjusting a heating temperature when bonding between a braking surface 1 of the gray cast iron material and a housing 2 of an aluminum alloy material is made. Accordingly, the bonding characteristics between the braking surface and the housing is improved and/or optimized. According to at least one of the embodiments, the bonding portion of the braking surface is, suitably, formed in n a wave shape, and a pitch spacing of the wave-shaped bonding portion is optimized. As a result, fuel economy and ride comfort can be improved and braking characteristics can be improved.

FIG. 1 illustrates a hybrid brake drum according to an embodiment of the present invention. A hybrid brake drum includes a braking surface 1 and a housing 2 in or to which the braking surface 1 is accommodated. The braking surface 1 is molded with a gray cast iron material having superior performances of vibration attenuation, damping, and lubrication, and the housing 2 is molded with an aluminum alloy material having superior specific strength, lightweight efficiency, and castability.

The braking surface 1 may be heated to the level of 600° C. by a heating plate connected thereto in an insulation sand mold, and thus the residual stress remaining in the gray cast iron can be removed. On the other hand, the braking surface 1 and the housing 2 are bonded at a temperature of 500° C. or higher, and thus the reactivity of the gray cast iron and the aluminum can become high. As a result, the hybrid bonding between the two materials can be optimized.

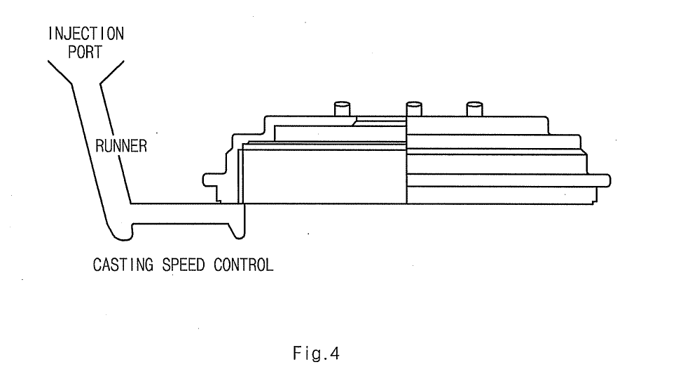

Preferably, a hybrid drum brake, as illustrated in FIG. 4, is made by a gravity casting method that can cast even a complicated structure with precise dimensions.

For instance, the braking surface 1 heated to the level of about 600° C. is used as a core during casting, and the aluminum alloy (preferably, Al—Si—Mg series alloy) is injected into an injection port at an injection temperature of about 700 to 800° C. Accordingly, the braking surface 1 is kept at a temperature of 500° C. or higher, and thus the reaction between the gray cast iron and the aluminum alloy is heightened to optimize the bonding.

For the aluminum alloy portion of the hybrid brake drum manufactured by the above-described bonding method to have high-strength property and for residual stress thereof to be removed, a thermal treatment including a solution treatment, a quenching process and an aging process is performed.

In detail, preferably, a supersaturated solid solution is formed through a solution treatment process for about 5 to 8 hours at about 450 to 500° C., followed by quenching and aging processes (for 3 to 5 hours at 190 to 210° C.), thereby achieving the high-strength security and the residual stress removal.

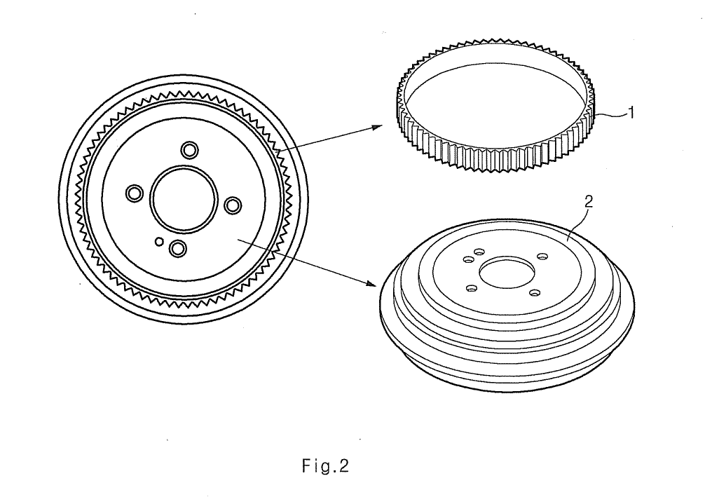

On the other hand, preferably, the bonding portion of the braking surface is formed in a wave shape, as illustrated in FIG. 2, to secure the castability and durability against the braking torque, and the bonding portion is formed with a pitch spacing of about 5 to 30 mm and a pitch depth of about 2 to 12 mm.

A preferable example of the aluminum alloy material that can be used to make the housing comprises aluminum (Al) as a principal component, 0.1 or less w % of copper (Cu), 5.5 to 8.5 w % of silicon (Si), 0.15 to 0.5 w % of magnesium (Mg), 0.1 or less w % of zinc (Zn), 0.3 or less w % of iron (Fe), 0.1 or less w % of manganese (Mn), 0.2 or less w % of titanium (Ti), and 0.15 or less w % of antimony (Sb), as described in Table 1 below.

TABLE 1

| | Component (%) | | | | | | | | |
|---|---|---|---|---|---|---|---|---|---|
| Material | Cu | Si | Mg | Zn | Fe | Mn | Ti | Sb | Al |
| Ai-Si—Mg | 0.10 | 5.5 | 0.15 | 0.1 | 0.30 | 0.10 | 0.20 | 0.10 | Remainder |
| Series | or | to | to | or | or | or | or | or | |
| Aluminum | less | 8.5 | 0.5 | less | less | less | less | less | |
| Alloy | | | | | | | | | |

A preferably example of the gray cast iron material that can be used to make the braking surface comprises iron (Fe) as a principal component, 3.0 to 3.8 w % of carbon (C), 1.0 to 2.8 w % of silicon (Si), 1.0 or less w % of manganese (Mn), 0.2 or less w % of phosphorus (P), and 0.15 or less w % of sulfur, as described in Table 2 below.

TABLE 2

| | Component (5) | | | | | |
|---|---|---|---|---|---|---|
| Material | C | Si | Mn | P | S | Fe |
| Gray Cast | 3.0 to | 1.2 to | 1.0 or | 1.2 or | 0.15 or | Remainder |
| Iron | 3.8 | 2.8 | less | less | less | |

According to the brake drum manufacturing process and the brake drum manufactured using the same according to the embodiments of the present invention, fuel economy can be improved due to the weight reduction of the vehicle and the ride comfort can be improved due to the reduced unsprung mass by applying a light weight aluminum alloy to the housing portion while satisfying required braking characteristics.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A method of manufacturing a brake drum for a vehicle, the method comprising:
bonding at a temperature of 500° C. or higher a braking surface which is made of a gray cast iron material with a housing which is to accommodate the brake surface and is made of an aluminum alloy material; and
removing residual stress that remains in the gray cast iron material by heating the braking surface at a temperature of about 600° C.

2. The method of claim 1, wherein in the case of casting the braking surface heated to the level of 600° C., the bonding between the braking surface of the gray cast iron material and the housing of the aluminum alloy material is guided by casting the housing of the aluminum alloy material at a temperature of 700 to 800° C.

3. The method of claim 1, wherein the residual stress removal comprises a solution treatment step, a quenching step, and an aging step.

4. The method of claim 1, wherein the bonding portion of the braking surface is formed in a wave shape.

5. The method of claim 1, wherein the wave-shaped bonding portion has a pitch spacing of about 5 to 30 mm and a pitch depth of about 2 to 12 mm.

6. The method of claim 1, wherein the aluminum alloy material comprises aluminum (Al) as a principal component, 0.1 or less w % of copper (Cu), 5.5 to 8.5 w % of silicon (Si), 0.15 to 0.5 w % of magnesium (Mg), 0.1 or less w % of zinc (Zn), 0.3 or less w % of iron (Fe), 0.1 or less w % of manganese (Mn), 0.2 or less w % of titanium (Ti), and 0.15 or less w % of antimony (Sb).

7. The method of claim 1, wherein the gray cast iron material comprises iron (Fe) as a principal component, 3.0 to 3.8 w % of carbon (C), 1.0 to 2.8 w % of silicon (Si), 1.0 or less w % of manganese (Mn), 0.2 or less w % of phosphorus (P), and 0.15 or less w % of sulfurs.

8. The method of claim 6, wherein the gray cast iron material comprises iron (Fe) as a principal component, 3.0 to 3.8 w % of carbon (C), 1.0 to 2.8 w % of silicon (Si), 1.0 or less w % of manganese (Mn), 0.2 or less w % of phosphorus (P), and 0.15 or less w % of sulfurs.

9. A brake drum manufactured by the method of claim 1.

10. A brake drum for a vehicle comprising:
a braking surface which is made of a gray cast iron material; and
a housing which is made of an aluminum alloy material and is to accommodate the brake surface,
wherein the braking surface and the housing are bonded and the bonding portion of the braking surface is formed in a wave shape.

11. The brake drum of claim 10, wherein the wave-shaped bonding portion has a pitch spacing of about 5 to 30 mm and a pitch depth of about 2 to 12 mm.

12. A brake drum for a vehicle comprising:
a braking surface which is made of a gray cast iron material; and
a housing which is made of an aluminum alloy material and is to accommodate the brake surface,
wherein the gray cast iron material comprises iron (Fe) as a principal component, 3.0 to 3.8 w % of carbon (C), 1.0 to 2.8 w % of silicon (Si), 1.0 or less w % of manganese (Mn), 0.2 or less w % of phosphorus (P), and 0.15 or less w % of sulfurs.

13. A brake drum for a vehicle comprising:
a braking surface which is made of a gray cast iron material; and
a housing which is made of an aluminum alloy material and is to accommodate the brake surface,
wherein the aluminum alloy material comprises aluminum (Al) as a principal component, 0.1 or less w % of copper (Cu), 5.5 to 8.5 w % of silicon (Si), 0.15 to 0.5 w % of magnesium (Mg), 0.1 or less w % of zinc (Zn), 0.3 or less w % of iron (Fe), 0.1 or less w % of manganese (Mn), 0.2 or less w % of titanium (Ti), and 0.15 or less w % of antimony (Sb).

14. The brake drum of claim 13, wherein the gray cast iron material comprises iron (Fe) as a principal component, 3.0 to 3.8 w % of carbon (C), 1.0 to 2.8 w % of silicon (Si), 1.0 or less w % of manganese (Mn), 0.2 or less w % of phosphorus (P), and 0.15 or less w % of sulfurs.
